(19) United States
(12) Patent Application Publication
(10) Pub. No.: US 2012/0307058 A1
(43) Pub. Date: Dec. 6, 2012

(54) CONVEX MIRROR ASSEMBLY

(76) Inventor: I-Chuan SHIH, Changhua County (TW)

(21) Appl. No.: 13/316,779

(22) Filed: Dec. 12, 2011

(30) Foreign Application Priority Data
May 30, 2011 (TW) 100209718

(51) Int. Cl. H04N 7/18

(52) U.S. Cl. 348/148

(57) ABSTRACT

A convex mirror assembly has a rear plate, a reflective plate and a video device. The reflective plate is connected securely with a front side of the rear plate and has a base plate. The base plate is pervious to light and has a window section. The video device is securely connected with the rear plate and has a camera aligning with the window section. The reflective plate provides a good reflecting effect and the video device also can record videos of the environment through the window section. Accordingly, the convex mirror assembly in accordance with the present invention has a reflecting and video recording effect and this is practical and convenient.

### BACKGROUND OF THE INVENTION

1. Field of the Invention

The present invention relates to a convex mirror assembly, and more particularly to a convex mirror assembly having a reflecting and video recording effect.

2. Description of Related Art

A conventional convex mirror assembly has a reflective plate. The reflective plate has a base plate, a metal film and a coating. The base plate has a convex front surface. The metal film securely covers a rear surface of the base plate. The coating securely covers the metal film and is opposite to the base plate. The conventional reflective plate provides a reflective effect to reflect an image at a corner, a convenience store or an L-shaped crossroad.

However, the reflective plate is opaque and cannot allow light from the environment to pass through the reflective plate. A video device cannot be mounted in the conventional convex mirror assembly to provide a video recording effect.

To overcome the shortcomings, the present invention tends to provide a convex mirror assembly to mitigate the aforementioned problems.

### SUMMARY OF THE INVENTION

The main objective of the invention is to provide a convex mirror assembly having a reflecting and video recording effect.

A convex mirror assembly has a rear plate, a reflective plate and a video device. The reflective plate is connected securely with a front side of the rear plate and has a base plate. The base plate is pervious to light and has a window section. The video device is securely connected with the rear plate and has a camera aligning with the window section. The reflective plate provides a good reflecting effect and the video device also can record videos of the environment through the window section. Accordingly, the convex mirror assembly in accordance with the present invention has a reflecting and video recording effect and this is practical and convenient.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a convex mirror assembly in accordance with the present invention;

FIG. 2 is a partially exploded perspective view of the convex mirror assembly in FIG. 1, showing that an arcuate strip is detached from the rear plate;

FIG. 3 is a partially exploded perspective view of the convex mirror assembly in FIG. 1;

FIG. 4 is another partially exploded perspective view of the convex mirror assembly in FIG. 3;

FIG. 5 is a side view in partial section of the convex mirror assembly in FIG. 1;

FIG. 6 is an enlarged cross sectional view of the reflective plate of the convex mirror assembly in FIG. 1; and

FIG. 7 is a perspective view of a second embodiment of the convex mirror assembly in accordance with the present invention.

### DETAILED DESCRIPTION OF PREFERRED EMBODIMENT

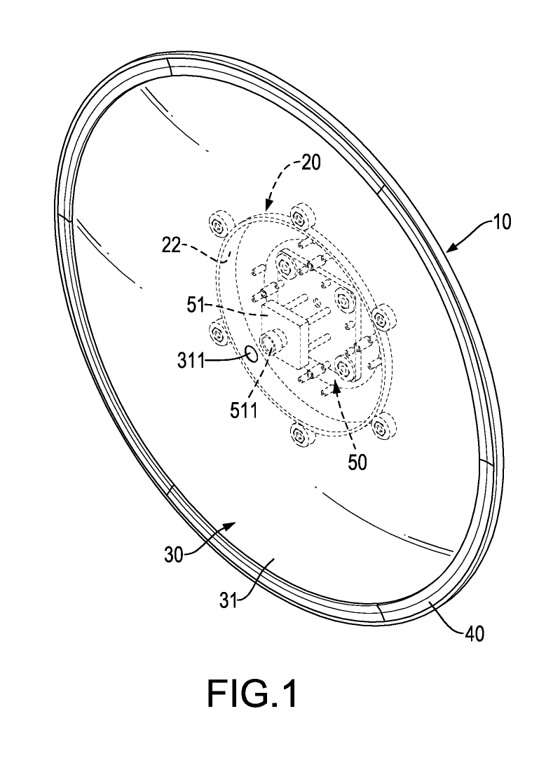

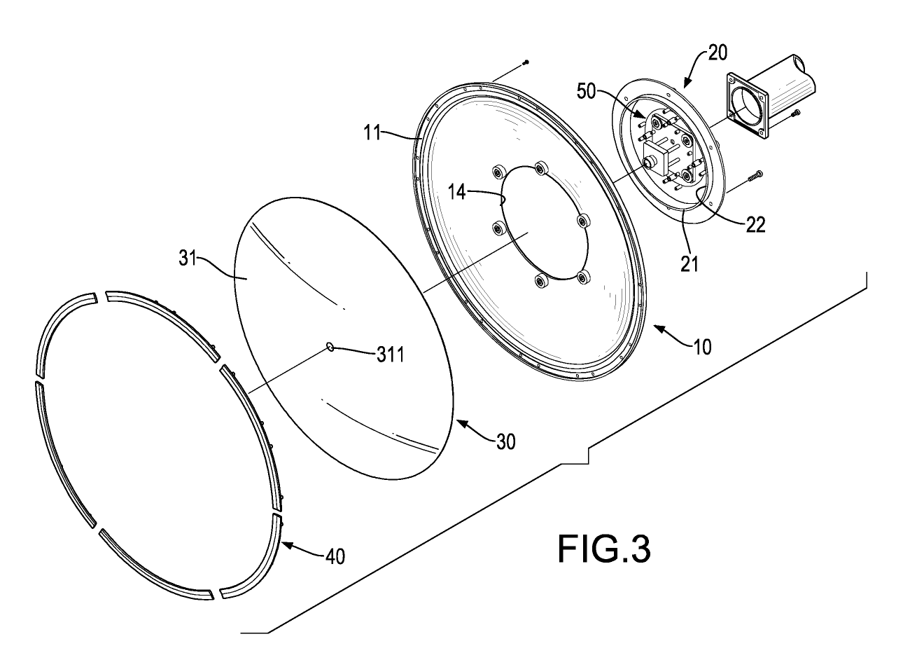

With reference to FIGS. 1 to 3, a first embodiment of a convex mirror assembly in accordance with the present invention comprises a rear plate 10, a bracket 20, a reflective plate 30, multiple arcuate strips 40 and a video device 50.

The rear plate 10 has a front side, a rear side, a concave space, an annular surface 11, multiple through holes 12, a rib 13 and a mounting opening 14. The rear side of the rear plate 10 is opposite to the front side of the rear plate 10. The concave space is located at the front side of the rear plate 10. The annular surface 11 is formed on the front side of the rear plate 10 and has an outer edge. The through holes 12 are formed through the annular surface 11. The rib 13 is annular and protrudes out from the outer edge of the annular surface 11. The mounting opening 14 may be circular and is axially formed through the rear plate 10.

With reference to FIGS. 1, 3 and 4, the bracket 20 is securely mounted through the rear plate 10 by screws and has a protrusion 21, a device recess 22 and a connecting recess 23. The protrusion 21 is annular and is securely inserted into the mounting opening 14. The device recess 22 is formed in the bracket 20 and is encompassed by the protrusion 21. The connecting recess 23 is formed in the bracket 20, is opposite to the device recess 22 and has a rectangular cross section.

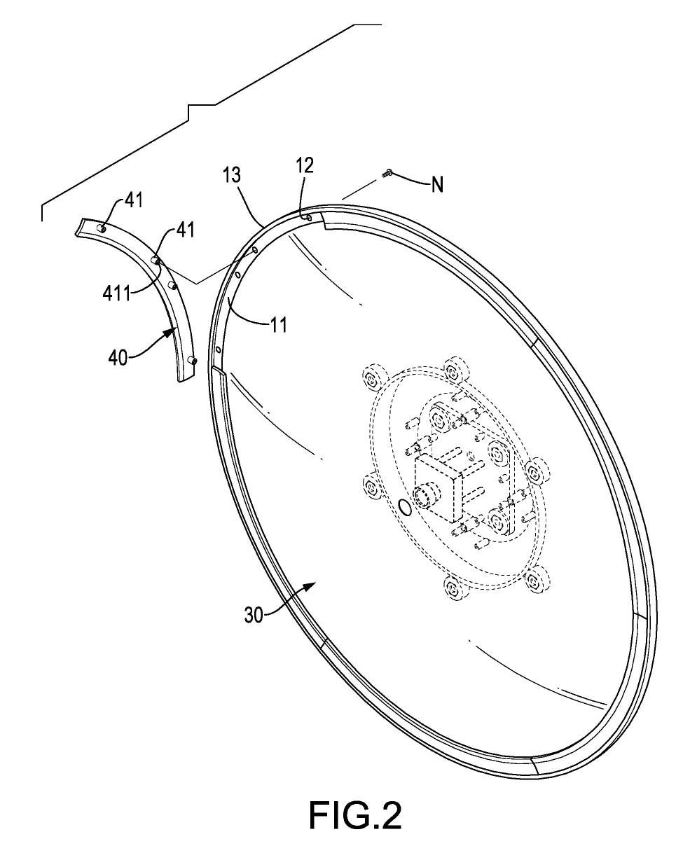

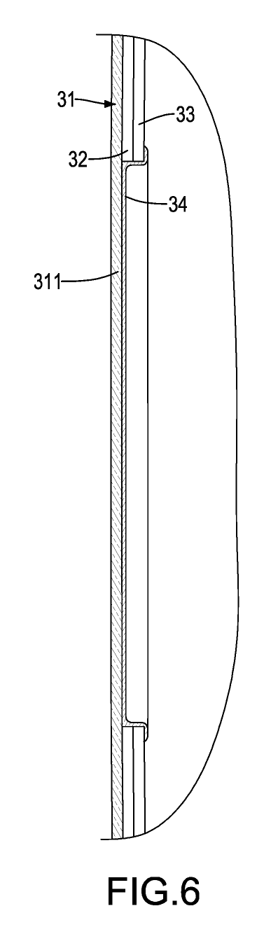

With reference to FIGS. 2, 3 and 6, the reflective plate 30 is connected securely with the front side of the rear plate 10 and has a base plate 31, an aluminum film 32, a first coating 33 and a second coating 34. The base plate 31 is pervious to light and has a convex front surface, a rear surface, a rim and a window section 311. The base plate 31 may be made of glass or acryl. The rear surface of the base plate 31 is opposite to the front surface of the base plate 31 and is securely connected with the front side of the rear plate 10. The rim of the base plate 31 abuts an inner side of the annular surface 11 of the rear plate 10. The window section 311 is pervious to light. Light from the environment can travel through the window section 311.

The aluminum film 32 securely covers the rear surface of the base plate 31 except the window section 311. The aluminum film 32 is connected with the base plate 31 by a process of thin-film deposition in a vacuum environment.

The first coating 33 is opaque, securely covers the aluminum film 32 and is opposite to the base plate 31.

The second coating 34 is pervious to light, securely covers the window section 311 and extends to an inner rim of the aluminum film 32 to cover the aluminum film 32. Accordingly, the aluminum film 32 can be prevented from being exposed to the environment.

With reference to FIGS. 2 to 4, the arcuate strips 40 are arranged to form a round, are securely mounted on the annular surface 11 of the rear plate 10 and abut the reflective plate 30. Each arcuate strip 40 has multiple pins 41. The pins 41 of the arcuate strips 40 are respectively inserted into the through holes 12 of the rear plate 10. Each pin 41 has a distal end and a threaded hole 411 axially formed in the distal end of the pin 41. Multiple screws N are respectively mounted through the through holes 12 of the rear plate 10 and are respectively screwed into the threaded holes 411. With the screws N, the arcuate strips 40 can securely abut the reflective plate 30 for secure positioning.

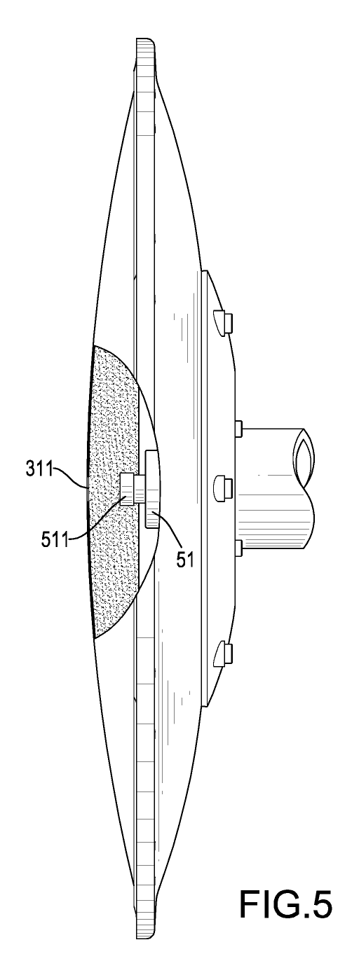

With reference to FIGS. 1, 3 and 5, the video device 50 is securely mounted behind the reflective plate 30 and has a camera 51. The camera 51 is mounted between the rear plate 10 and the reflective plate 30 and has a front end, a rear end and a lens 511. The rear end of the camera 51 is opposite to the front end of the camera 51 and is securely positioned inside the device recess 22. The lens 511 is formed at the front end of the camera 51 and aligns with the window section 311. Accordingly, the camera 51 can record videos of the environment through the window section 311.

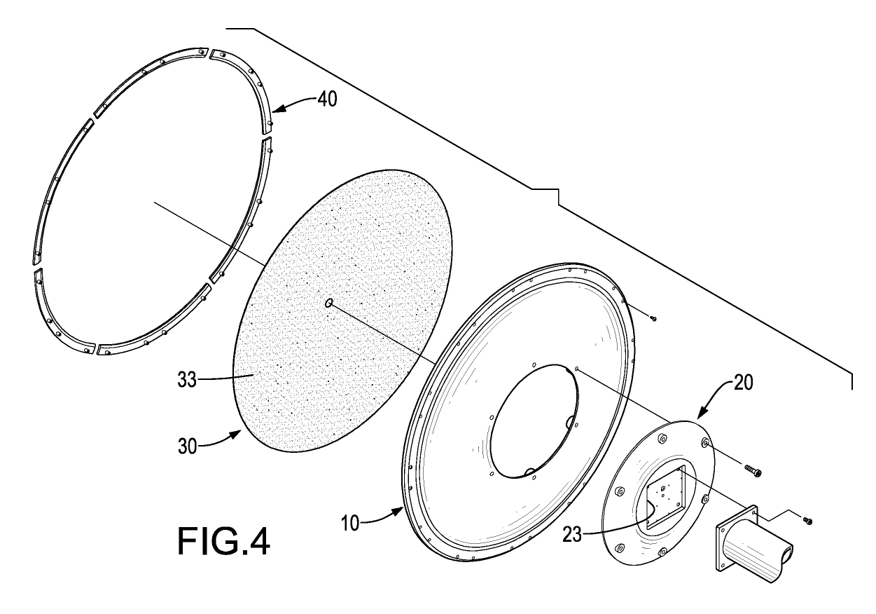

With reference to FIGS. 1 and 4, a fixing rod is connected securely on the connecting recess 23 of the bracket 20. The reflective plate 30 provides a reflective effect to reflect an image at a corner, a convenience store or an L-shaped crossroad. With the first coating 33, light passing through the window section 311 can be reflected inside the reflective plate 30.

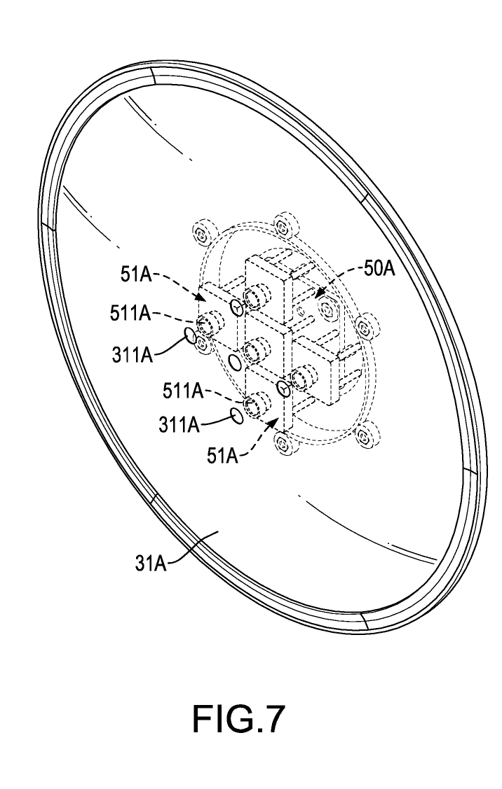

With reference to FIG. 7, a second embodiment of the convex mirror assembly is substantially the same as the first embodiment except the following features.

The base plate 31A has multiple window sections 311A. Preferably, five window sections 311A are implemented. The window sections 311A are arranged to form a crisscross. The video device 50A has multiple cameras 51A. The lens 511A of the cameras 51A respectively align with the window sections 311A.

From the above description, it is noted that the present invention has the following advantage: the reflective plate 30 provides a good reflecting effect and the video device 50 also can record videos of the environment through the window section 311. Accordingly, the convex mirror assembly in accordance with the present invention has a reflecting and video recording effect and this is practical and convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A convex mirror assembly comprising:
a rear plate having
a front side;
a rear side opposite to the front side of the rear plate; and
a concave space located at the front side of the rear plate;
a reflective plate connected securely with the front side of the rear plate and having
a base plate pervious to light and having
a convex front surface;
a rear surface opposite to the front surface of the base plate and securely connected with the front side of the rear plate; and
a window section pervious to light;
an aluminum film securely covering the rear surface of the base plate except the window section; and
an opaque first coating securely covering the aluminum film and opposite to the base plate; and
a video device securely mounted behind the reflective plate and having
a camera mounted between the rear plate and the reflective plate and having
a front end; and
a lens formed at the front end of the camera and aligning with the window section.

2. The convex mirror assembly as claimed in claim 1, wherein
the reflective plate further has a second coating pervious to light, securely covering the window section and extending to a rim of the aluminum film to cover the aluminum film.

3. The convex mirror assembly as claimed in claim 2, wherein
the aluminum film is connected with the base plate by a process of
thin-film deposition in a vacuum environment.

4. The convex mirror assembly as claimed in claim 1, wherein the base plate is made of polycarbonate.

5. The convex mirror assembly as claimed in claim 2, wherein the base plate is made of polycarbonate.

6. The convex mirror assembly as claimed in claim 3, wherein the base plate is made of polycarbonate.

7. The convex mirror assembly as claimed in claim 1, wherein the base plate is transparent and is made of glass.

8. The convex mirror assembly as claimed in claim 2, wherein the base plate is transparent and is made of glass.

9. The convex mirror assembly as claimed in claim 3, wherein the base plate is transparent and is made of glass.

10. The convex mirror assembly as claimed in claim 1, wherein the base plate is made of acryl.

11. The convex mirror assembly as claimed in claim 2, wherein the base plate is made of acryl.

12. The convex mirror assembly as claimed in claim 3, wherein the base plate is made of acryl.

13. The convex mirror assembly as claimed in claim 1, wherein the base plate is made of Polyethylene terephthalate.

14. The convex mirror assembly as claimed in claim 2, wherein the base plate is made of Polyethylene terephthalate.

15. The convex mirror assembly as claimed in claim 3, wherein the base plate is made of Polyethylene terephthalate.
